(19) United States
(12) Patent Application Publication
(10) Pub. No.: US 2024/0339851 A1
(43) Pub. Date: Oct. 10, 2024

(54) FORWARD-BACKWARD BOOST-BUCK CHARGING AND DISCHARGING CIRCUIT AND ELECTRIC TOOL

(71) Applicant: SHENZHEN HONOR ELECTRONIC CO., LTD, Shenzhen (CN)

(72) Inventors: Liang Liu, Shenzen (CN); Yuetian Wang, Shenzen (CN)

(21) Appl. No.: 18/578,630

(22) PCT Filed: Jun. 10, 2022
(86) PCT No.: PCT/CN2022/098096

§ 371 Date: Jan. 11, 2024

(30) Foreign Application Priority Data
Jan. 4, 2022 (CN) 202210016705.7

(51) Int. Cl. H02J 7/00; H02M 3/158

(52) U.S. Cl. CPC H02J 7/007; H02J 7/00304; H02J 7/0063; H02M 3/1582; H02J 2207/20

(57) ABSTRACT

The present disclosure provides a forward-backward boost-buck charging and discharging circuit and an electric tool. The forward-backward boost-buck charging and discharging circuit comprises a battery, a forward-backward boost-buck charging and discharging unit and a first control unit, wherein the battery is configured to store power and supply power to a load; the forward-backward boost-buck charging and discharging unit is configured to charge and discharge the battery; the first control unit is configured to control the forward-backward boost-buck charging and discharging unit to supply power to the load, and to control the forward-backward boost-buck charging and discharging unit to boost or buck an external input voltage to charge the battery; the forward-backward boost-buck charging and discharging unit is connected to the battery and the first control unit. The forward-backward boost-buck charging and discharging circuit and the electric tool according to the embodiments of the present disclosure improve the charging efficiency.

### TECHNICAL FIELD

The present disclosure relates to a technical field of electric tools, and particularly to a forward-backward boost-buck charging and discharging circuit and an electric tool.

### BACKGROUND

Many traditional electric tools in the market only have a separate discharge function. When a lithium battery runs out, it needs to be disassembled to be charged by a charger, and then mounted on the electric tool for use after the charging is finished.

### SUMMARY

The charging efficiency of the electric tool is low since the lithium battery needs to be disassembled. Aiming at the problem that the rechargeable battery needs to be disassembled during charging, the embodiments of the present disclosure provide a forward-backward buck-boost charging and discharging circuit and an electric tool, which can at least partially solve the above problem.

In an aspect, the present disclosure proposes a forward-backward boost-buck charging and discharging circuit, comprising a battery, a forward-backward boost-buck charging and discharging unit and a first control unit, wherein:
the battery is configured to store power and supply power to a load;
the forward-back ward boost-buck charging and discharging unit is configured to charge and discharge the battery;
the first control unit is configured to control the forward-backward boost-buck charging and discharging unit to boost or buck to supply power to the load, and to control the forward-backward boost-buck charging and discharging unit to boost or buck an external input voltage to charge the battery;
the battery is connected to the forward-backward boost-buck charging and discharging unit, and the forward-backward boost-buck charging and discharging unit is connected to the first control unit.

Further, the forward-backward boost-buck charging and discharging unit comprises a first switching tube, a second switching tube, a third switching tube, a fourth switching tube, a first inductor, a first capacitor and a second capacitor, wherein;
the first switching tube is connected in series with the second switching tube, the third switching tube is connected in series with the fourth switching tube, a anode of the battery is connected to a first end of the first switching tube, the first end of the first switching tube is connected to a first end of the first capacitor, a second end of the first capacitor is connected to a first end of the second capacitor, a second end of the second capacitor is connected to a first end of the third switching tube, the second end of the first capacitor and the first end of the second capacitor are grounded, a first end of the first inductor is connected between the first switching tube and the second switching tube, a second end of the first inductor is connected between the third switching tube and the fourth switching tube, a second end of the second switching tube and a second end of the fourth switching tube are connected to an cathode of the battery, respectively;
the first control unit is configured to drive the first switching tube, the second switching tube, the third switching tube and the fourth switching tube, so as to boost or buck the battery to supply power to the load, and to boost or buck the external input voltage to charge the battery.

Further, the forward-backward boost-buck charging and discharging circuit further comprises a current limiting unit configured to perform a current limiting protection for the forward-backward boost-buck charging and discharging circuit.

Further, the forward-backward boost-buck charging and discharging circuit further comprises at least one noise reduction unit, which is connected in parallel with the first switching tube, the second switching tube, the third switching tube or the fourth switching tube.

Further, the forward-backward boost-buck charging and discharging circuit further comprises at least one filter capacitor, each of which is connected in parallel with the battery.

Further, the forward-backward boost-buck charging and discharging circuit further comprises a second control unit, which is connected to the first control unit and is configured to trigger the first control unit to control the forward-backward boost-buck charging and discharging unit to boost or back to supply power to the load, and to control the forward-backward boost-buck charging and discharging unit to boost or buck the external input voltage to charge the battery.

Further, the forward-backward boost-buck charging and discharging circuit further comprises an input protection unit, which is connected to the second control unit and is configured to perform an overcurrent protection for the forward-backward boost-buck charging and discharging circuit.

Further, the input protection unit comprises a first resistor, a second resistor, a third resistor, a fourth resistor, a fifth resistor, a sixth resistor, a third capacitor, a fourth capacitor, a fifth capacitor and a comparator, wherein:
a first end of the first resistor is grounded, a second end of the first resistor is connected to a first end of the second resistor, and the second end of the first resistor is coupled to an cathode circuit of the battery; a first end of the third capacitor is connected to a second end of the second resistor, and a second end of the third capacitor is grounded; a first end of the third resistor is grounded, a second end of the third resistor is connected to a first end of the fourth resistor and a first end of the fourth capacitor, respectively, and a second end of the fourth resistor and a second end of the fourth capacitor are grounded; a first input end of the comparator is connected to the second end of the second resistor, a second input end of the comparator is connected between the third resistor and the fourth resistor, and an output end of the comparator is connected to a first end of the sixth resistor; a first end of the fifth resistor is connected to a second end of the sixth resistor, a second end of the fifth resistor is connected to an output end of the comparator, the second end of the sixth resistor is connected to a first end of the fifth capacitor, a second end of the fifth capacitor is grounded, and the second end of the sixth resistor is connected to the second control unit.

Further, the input protection unit further comprises a seventh resistor and a sixth capacitor, wherein;
a first end of the sixth capacitor is connected to the first end of the fifth resistor, a second end of the sixth capacitor is connected to a first end of the seventh resistor, and a second end of the seventh resistor is connected to the second end of the fifth resistor.

Further, the input protection unit comprises a switching unit, which comprises a ninth resistor, a tenth resistor, an eleventh resistor, a twelfth resistor, a triode, a voltage stabilizing diode, a field effect transistor and a common mode choke, wherein:
a first end of the eleventh resistor is connected to the second control unit, a second end of the eleventh resistor is connected to a base of the triode, an emitter of the triode is grounded, a first end of the ninth resistor is connected to a second end of the eleventh resistor, a second end of the ninth resistor is grounded, a first end of the tenth resistor is connected to a collector of the triode, a second end of the tenth resistor is connected to a first end of the voltage stabilizing diode, a first end of the twelfth resistor and a source of the field effect transistor, respectively, a second end of the voltage stabilizing diode and a second end of the twelfth resistor are connected to a gate of the field effect transistor, respectively, a drain of the field effect transistor is connected to the common mode choke, the gate of the field effect transistor is connected to a anode of the battery, and the common mode choke is connected to an cathode of the battery.

Further, the forward-backward boost-buck charging and discharging circuit further comprises a bucking unit, which is connected to the second control unit and is configured to buck an output voltage of the switching unit to a preset voltage.

Further, the bucking unit comprises a fifth switching tube, a sixth switching tube, an eighth resistor, a second inductor and a third control unit, wherein:
a first end of the fifth switching tube is connected to the anode of the battery, a second end of the fifth switching tube is connected to a first end of the eighth resistor, a second end of the eighth resistor is connected to a first end of the sixth switching tube and a first end of the second inductor, respectively, a second end of the sixth switching tube is grounded, a second end of the second inductor is connected to a bucking output end, and the fifth switching tube and the sixth switching tube are connected to the third control unit, respectively.

Further, the bucking unit further comprises at least one second noise reduction unit which is connected in parallel with the fifth switching tube or the sixth switching tube.

In another aspect, the present disclosure proposes an electric tool, comprising the forward-backward boost-buck charging and discharging circuit according to any of the aforementioned embodiments.

The forward-backward boost-buck charging and discharging circuit according to the embodiment of the present disclosure includes a battery, a forward-backward boost-buck charging and discharging unit and a first control unit, wherein the battery is configured to store power and supply power to a load; the forward-backward boost-buck charging and discharging unit is configured to charge and discharge the battery; the first control unit is configured to control the forward-backward boost-buck charging and discharging unit to boost or buck to supply power to the load, and to control the forward-backward boost-buck charging and discharging unit to boost or buck an external input voltage to charge the battery; the battery is connected to the forward-backward boost-buck charging and discharging unit, and the forward-backward boost-buck charging and discharging unit is connected to the first control unit, so that the charging function can be realized without disassembling the battery, and the charging efficiency can be improved.

### BRIEF DESCRIPTION OF THE DRAWINGS

In order to more clearly explain the technical solutions in embodiments of the present disclosure or in the prior art, the drawings required for describing the embodiments or the prior art will be briefly introduced below. Obviously, the drawings involved in the following description just illustrate some embodiments of the present disclosure, and those of ordinary skills in the art can obtain other drawings from them without paying any creative effort. In the drawings,

FIG. 1 is a schematic structural diagram of a forward-backward boost-buck charging and discharging circuit according to a first embodiment of the present disclosure.

FIG. 2 is a schematic structural diagram of a forward-backward boost-buck charging and discharging circuit according to a second embodiment of the present disclosure.

FIG. 3 is a schematic structural diagram of a forward-backward boost-buck charging and discharging circuit according to a third embodiment of the present disclosure.

FIG. 4 is a schematic structural diagram of a forward-backward boost-buck charging and discharging circuit according to a fourth embodiment of the present disclosure.

FIG. 5 is a schematic structural diagram of a forward-backward boost-buck charging and discharging circuit according to a fifth embodiment of the present disclosure.

FIG. 6 is a schematic structural diagram of a forward-backward boost-buck charging and discharging circuit according to a sixth embodiment of the present disclosure.

FIG. 7 is a schematic structural diagram of a forward-backward boost-buck charging and discharging circuit according to a seventh embodiment of the present disclosure.

FIG. 8 is a schematic structural diagram of a forward-backward boost-buck charging and discharging circuit according to an eighth embodiment of the present disclosure.

FIG. 9 is a schematic structural diagram of a forward-backward boost-buck charging and discharging circuit according to a ninth embodiment of the present disclosure,

FIG. 10 is a schematic structural diagram of an input protection unit according to a tenth embodiment of the present disclosure.

FIG. 11 is a schematic structural diagram of an input protection unit according to an eleventh embodiment of the present disclosure.

FIG. 12 is a schematic structural diagram of an input protection unit provided according to a twelfth embodiment of the present disclosure.

FIG. 13 is a schematic structural diagram of a forward-backward boost-buck charging and discharging circuit according to a thirteenth embodiment of the present disclosure.

FIG. 14 is a schematic structural diagram of a bucking unit according to a fourteenth embodiment of the present disclosure.

FIG. 15 is a schematic structural diagram of a bucking unit according to a fifteenth embodiment of the present disclosure.

FIG. 16 is a schematic structural diagram of a bucking unit according to a sixteenth embodiment of the present disclosure.

FIG. 17 is a schematic structural view of the electric tool according to a seventeenth embodiment of the present disclosure.

### DETAILED DESCRIPTION OF THE PREFERRED EMBODIMENTS

In order that the objectives, technical solutions and advantages of the embodiments of the present disclosure are clearer, the embodiments of the present disclosure are further described in detail below with reference to the drawings. Here, the exemplary embodiments of the present disclosure and the description thereof are used to explain, rather than limiting the present disclosure. It should be noted that the embodiments of the present disclosure and the features in the embodiments can be combined with each other arbitrarily without conflict.

FIG. 1 is a schematic structural diagram of a forward-backward boost-buck charging and discharging circuit according to a first embodiment of the present disclosure. As illustrated in FIG. 1, the forward-backward boost-buck charging and discharging circuit according to the embodiment of the present disclosure includes a battery 1, a forward-backward boost-buck charging and discharging unit 2 and a first control unit 3, wherein:
the battery 1 is configured to store power and supply power to a load;
the forward-backward boost-buck charging and discharging unit 2 is configured to charge and discharge the battery 1;
the first control unit 2 is configured to control the forward-backward boost-buck charging and discharging unit 3 to boost or buck to supply power to the load, and to control the forward-backward boost-buck charging and discharging unit 3 to boost or buck an external input voltage to charge the battery 1;
the battery 1 is connected to the forward-backward boost-buck charging and discharging unit 2, and the forward-backward boost-buck charging and discharging unit 2 is connected to the first control unit 3.

Specifically, the forward-backward boost-buck charging and discharging circuit according to the present disclosure has two working states: a forward power supply state and a backward charging state. In the forward power supply state, if a voltage output from an output end is required to be lower than a DC voltage of the battery 1, the first control unit 3 controls the forward-backward boost-buck charging and discharging unit 2 to buck and output the voltage supplied by the battery 1 to the output end; and if the voltage output from the output end is required to be higher than the DC voltage of the battery 1, the first control unit 2 controls the forward-backward boost-buck charging and discharging unit 3 to boost and output the voltage supplied by the battery 1 to the output end. In the backward charging state, if a charging voltage of the battery 1 is lower than the voltage at the output end, the first control unit 2 controls the forward-backward boost-buck charging and discharging unit 3 to buck and output the external input voltage supplied by the output end to the battery 1 to buck and charge the battery 1; and if the charging voltage of the battery 1 is higher than the voltage at the output end, the first control unit 2 controls the forward-backward boost-buck charging and discharging unit 3 to boost and output the voltage supplied by the battery 1 to the battery 1, and boost and charge the battery 1 through the voltage at the output end.

The forward-backward boost-buck charging and discharging circuit according to the embodiment of the present disclosure includes a battery, a forward-backward boost-buck charging and discharging unit and a first control unit, wherein the battery is configured to store power and supply power to a load; the forward-backward boost-buck charging and discharging unit is configured to charge and discharge the battery; the first control unit is configured to control the forward-backward boost-buck charging and discharging unit to boost or buck to supply power to the load, and to control the forward-backward boost-buck charging and discharging unit to boost or buck an external input voltage to charge the battery; the battery is connected to the forward-backward boost-buck charging and discharging unit, and the forward-backward boost-buck charging and discharging unit is connected to the first control unit, so that the charging function can be realized without disassembling the battery, and the charging efficiency can be improved.

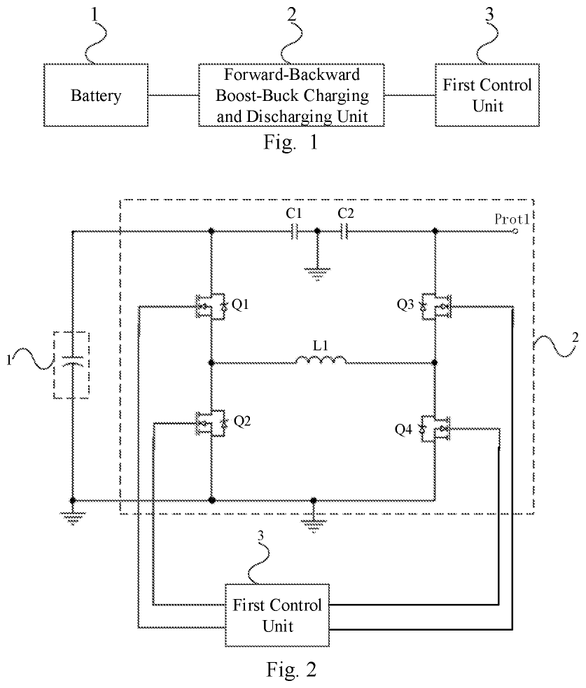

FIG. 2 is a schematic structural diagram of a forward-backward boost-buck charging and discharging circuit according to a second embodiment of the present disclosure. As illustrated in FIG. 2, on the basis of the aforementioned embodiment, the forward-backward boost-buck charging and discharging unit 2 according to the embodiment of the present disclosure further includes a first switching tube Q21, a second switching tube Q2, a third switching tube Q3, a fourth switching tube Q4, a first inductor L1, a first capacitor C1 and a second capacitor C2, wherein:
the first switching tube Q1 is connected in series with the second switching tube Q2, the third switching tube Q3 is connected in series with the fourth switching tube Q4, a anode of the battery 1 is connected to a first end of the first switching tube Q1, the first end of the first switching tube Q1 is connected to a first end of the first capacitor C1, a second end of the first capacitor C1 is connected to a first end of the second capacitor C2, a second end of the second capacitor C2 is connected to a first end of the third switching tube Q3, the second end of the first capacitor C1 and the first end of the second capacitor C2 are grounded, a first end of the first inductor L1 is connected between the first switching tube Q1 and the second switching tube Q2, a second end of the first inductor L1 is connected between the third switching tube Q3 and the fourth switching tube Q4, a second end of the second switching tube Q2 and a second end of the fourth switching tube Q4 are connected to an cathode of the battery 1, respectively, and the cathode of the battery 1 may be grounded. Port1 is an output end of the forward-backward boost-buck charging and discharging unit 2.

The first control unit 3 is connected to the first switching tube Q1, the second switching tube Q2, the third switching tube Q3 and the fourth switching tube Q4, respectively, and is configured to drive the first switching tube Q1, the second switching tube Q2, the third switching tube Q3 and the fourth switching tube Q4 to boost or buck the battery 1 to supply power to the load, and to boost or buck an external input voltage to charge the battery 1. The battery 1 may adopt a lithium battery pack, and the first control unit 3 may adopt a control chip of model SC8815. The first switching transistor Q1, the second switching transistor Q2, the third switching transistor Q3 and the fourth switching transistor Q4 may adopt Metal-Oxide-Semiconductor Field-Effect Transistors (MOSFETs).

Specifically, the forward-backward boost-buck charging and discharging circuit according to the present disclosure has two working states: a forward power supply state and a backward charging state. In the forward power supply state, if a voltage output from an output end is required to be lower than a voltage of the battery 1, the first switching tube Q1 and the second switching tube Q22 are turned on as upper and lower bridge arms under the drive of the first control unit 3, the first inductor L1 serves as a bucking inductor, and the third switching tube Q3 is turned on simultaneously, so that the output end can output a DC voltage lower than the voltage of the battery 1; and if the voltage output from the output end is required to be higher than the voltage of the battery 1, the first switching tube Q1 is turned on, the first inductor L1 serves as a boosting inductor, and the third switching tube Q3 and the fourth switching tube Q4 are turned on as upper and lower bridge arms under the drive of the first control unit 3, so that the output end can output a DC voltage higher than the voltage of the battery 1. In the backward charging state, if a backward charging voltage of the battery 1 is lower than the voltage at the output end, the first switching tube Q1 and the second switching tube Q2 are turned on as upper and lower bridge arms under the drive of the first control unit 3, the first inductor L1 serves as a bucking inductor, and the third switching tube Q3 is turned on simultaneously, so as to buck and charge the battery 1 through the voltage at the output end; and if the backward charging voltage of the battery 1 is higher than the voltage at the output end, the first switching tube Q1 is turned on, the first inductor L1 serves as a boosting inductor, and the third switching tube Q3 and the fourth switching tube Q24 are turned on as upper and lower bridge arms under the drive of the first control unit 3, so as to boost and charge the battery 1 through the voltage at the output end. The first capacitor C1 and the second capacitor C2 function to supplement the working frequency.

On the basis of the aforementioned embodiments, the forward-backward boost-buck charging and discharging circuit according to the present disclosure further includes a current limiting unit configured to perform a current limiting protection for the forward-backward boost-buck charging and discharging circuit.

Specifically, the current limiting unit may be disposed on a line connecting the battery 1 and the first switching tube Q1, a first end of the current limiting unit is connected to the anode of the battery 1, and a second end of the current limiting unit is connected to the first end of the first switching tube Q1.

On the basis of the aforementioned embodiments, the current limiting unit further includes at least one current limiting resistor, each of which has a first end connected to the anode of the battery 1, and a second end connected to the first end of the first switching tube Q1. The number of the current limiting resistors is set according to actual needs, which is not limited herein. The resistance of each current limiting resistor is set according to actual needs, which is not limited herein.

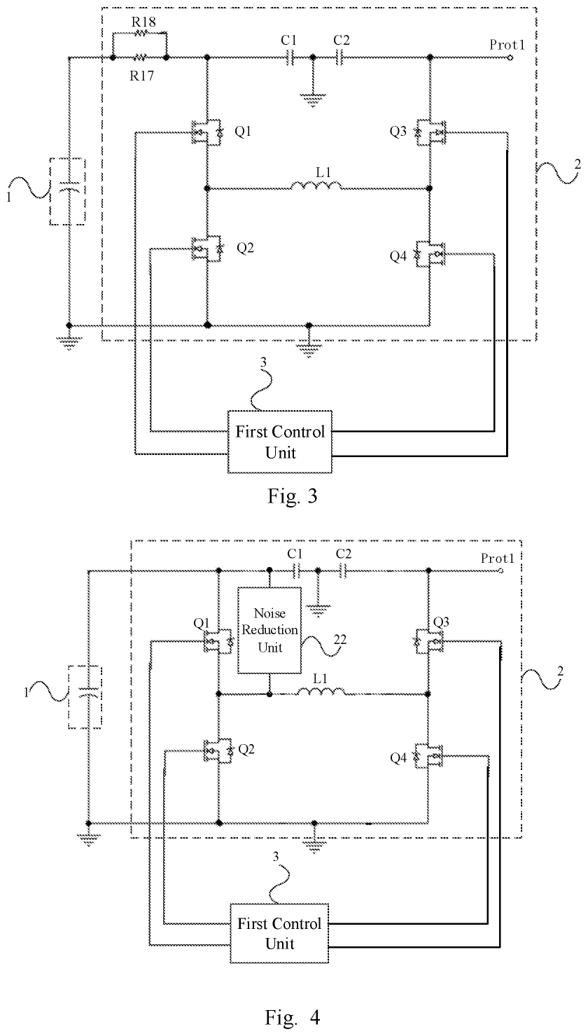

For example, as illustrated in FIG. 3, the current limiting unit includes a first current limiting resistor R17 and a second current limiting resistor R18, wherein a first end of the first current limiting resistor R17 and a first end of the second current limiting resistor R18 are connected to the anode of the battery 1, respectively: a second end of the first current limiting resistor R17 and a second end of the second current limiting resistor R18 are connected to the first end of the first switching tube Q1, respectively.

FIG. 4 is a schematic structural diagram of a forward-backward boost-buck charging and discharging circuit according to a fourth embodiment of the present disclosure. As illustrated in FIG. 4, on the basis of the aforementioned embodiments, the forward-backward boost-buck charging and discharging circuit according to the present disclosure further includes at least one noise reduction unit 22, which is connected in parallel with the first switching tube Q1, the second switching tube Q2, the third switching tube Q3 or the fourth switching tube Q4. The noise reduction unit 22 is configured to reduce a noise signal of the switching tube.

Specifically, at least one noise reduction unit 22 may be connected in parallel with one or more of the first switching tube Q1, the second switching tube Q2, the third switching tube Q3 and the fourth switching tube Q4. The specific arrangement mode and the number of the noise reduction units 22 are set according to actual needs, which is not limited herein.

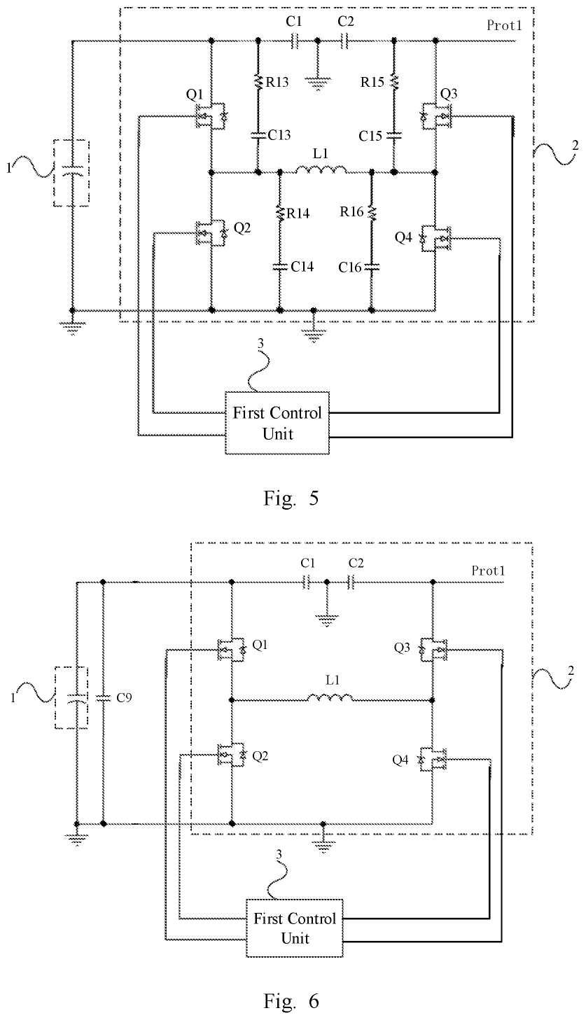

For example, FIG. 5 is a schematic structural diagram of a forward-backward boost-buck charging and discharging circuit according to a fifth embodiment of the present disclosure. As illustrated in FIG. 5, on the basis of the aforementioned embodiments, the forward-backward boost-buck charging and discharging unit 2 further includes four noise reduction units, i.e., a first noise reduction unit, a second noise reduction unit, a third noise reduction unit and a fourth noise reduction unit, wherein:
the first noise reduction unit includes a thirteenth resistor R13 and a thirteenth capacitor C13, wherein the thirteenth resistor R13 is connected in series with the thirteenth capacitor C13 and then connected in parallel with the first switching tube Q1, that is, a first end of the thirteenth resistor R13 is connected to the first end of the first switching tube Q1, and a second end of the thirteenth capacitor C13 is connected to the second end of the first switching tube Q1;
the second noise reduction unit includes a fourteenth resistor R14 and a fourteenth capacitor C14, wherein the fourteenth resistor R14 is connected in series with the fourteenth capacitor C14 and then connected in parallel with the second switching tube Q2, that is, a first end of the fourteenth resistor R14 is connected to the first end of the second switching tube Q2, the first end of the fourteenth resistor R14 is connected to the first end of the fourteenth capacitor C14, and a second end of the fourteenth capacitor C14 is connected to the second end of the second switching tube Q2;
the third noise reduction unit includes a fifteenth resistor R15 and a fifteenth capacitor C15, wherein the fifteenth resistor R15 is connected in series with the fifteenth capacitor C15 and then connected in parallel with the third switching tube Q3, that is, a first end of the fifteenth resistor R15 is connected to the first end of the third switching tube Q3, the first end of the fifteenth resistor R15 is connected to the first end of the fifteenth capacitor C15, and a second end of the fifteenth capacitor C15 is connected to the second end of the third switching tube Q3;
the fourth noise reduction unit includes a sixteenth resistor R16 and a sixteenth capacitor C16, wherein the sixteenth resistor R16 is connected in series with the sixteenth capacitor C16 and then connected in parallel with the fourth switching tube Q4, that is, a first end of the sixteenth resistor R16 is connected to the first end of the fourth switching tube Q4, the first end of the sixteenth resistor R16 is connected to the first end of the sixteenth capacitor C16, and a second end of the sixteenth capacitor C16 is connected to the second end of the fourth switching tube Q4.

The first noise reduction unit, the second noise reduction unit, the third noise reduction unit and the fourth noise reduction unit can reduce the noise signal of the switching tube.

FIG. 6 is a schematic structural diagram of a forward-backward boost-buck charging and discharging circuit according to a sixth embodiment of the present disclosure. As illustrated in FIG. 6, on the basis of the aforementioned embodiments, the forward-backward boost-buck charging and discharging circuit according to the embodiment of the present disclosure further includes at least one filter capacitor C9, each of which is connected in parallel with the battery 1. The filter capacitor C9 functions for filtering. In which, the specific number of the filter capacitors C9 is set according to actual needs, for example, four filter capacitors are disposed, which is not limited herein.

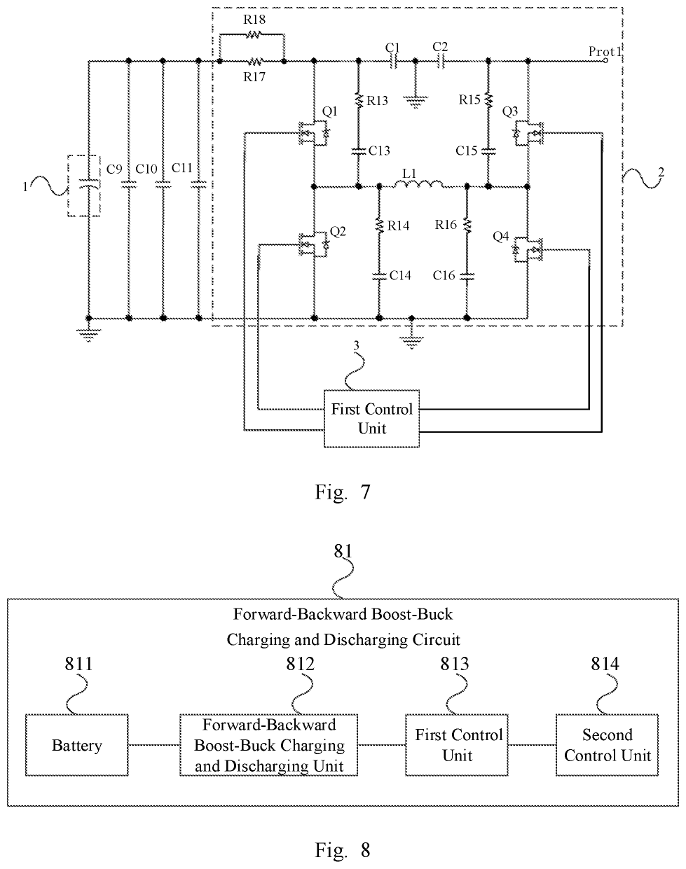

FIG. 7 is a schematic structural diagram of a forward-backward boost-buck charging and discharging circuit according to a seventh embodiment of the present disclosure. As illustrated in FIG. 7, the forward-backward boost-buck charging and discharging circuit according to the present disclosure includes a battery 1, three filter capacitors, a forward-backward boost-buck charging and discharging unit 2 and a first control unit 3, wherein:

the forward-backward boost-buck charging and discharging unit 2 includes a first switching tube Q1, a second switching tube Q2, a third switching tube Q3, a fourth switching tube Q24, the first noise reduction unit, the second noise reduction unit, the third noise reduction unit, the fourth noise reduction unit, a first inductor L1, a first capacitor C1, a second capacitor C2, a first current limiting resistor R17 and a second current limiting resistor R18; the first switching tube Q1 is connected in series with the second switching tube Q2, the third switching tube Q3 is connected in series with the fourth switching tube Q4, a anode of the battery 1 is connected to a first end of the first switching tube Q1, a first end of the first switching tube Q1 is connected to a first end of the first capacitor C1, a second end of the first capacitor C1 is connected to a first end of the second capacitor C2, a second end of the second capacitor C2 is connected to a first end of the third switching tube Q3, the second end of the first capacitor C1 and the first end of the second capacitor C2 are grounded, a first end of the first inductor L1 is connected between the first switching tube Q1 and the second switching tube Q2, a second end of the first inductor L1 is connected between the third switching tube Q3 and the fourth switching tube Q4, a second end of the second switching tube Q2 and a second end of the fourth switching tube Q4 are connected to an cathode of the battery 1, respectively, and the cathode of the battery is grounded.

The first noise reduction unit includes a thirteenth resistor R13 and a thirteenth capacitor C13, wherein the thirteenth resistor R13 is connected in series with the thirteenth capacitor C13 and then connected in parallel with the first switching tube Q1; the second noise reduction unit includes a fourteenth resistor R14 and a fourteenth capacitor C14, wherein the fourteenth resistor R14 is connected in series with the fourteenth capacitor C14 and then connected in parallel with the second switching tube Q2; the third noise reduction unit includes a fifteenth resistor RIS and a fifteenth capacitor C15, wherein the fifteenth resistor R15 is connected in series with the fifteenth capacitor CIS and then connected in parallel with the third switching tube Q3; the fourth noise reduction unit includes a sixteenth resistor R16 and a sixteenth capacitor C16, wherein the sixteenth resistor R16 is connected in series with the sixteenth capacitor C16 and then connected in parallel with the fourth switching tube Q4.

A first end of the first current limiting resistor R17 and a first end of the second current limiting resistor R18 are connected to the anode of the battery 1, respectively. A second end of the first current limiting resistor R17 and a second end of the second current limiting resistor R18 are connected to the first end of the first switching tube Q1, respectively. The first filter capacitor C9, the second filter capacitor C10 and the third filter capacitor CHI are connected in parallel with the battery 1, respectively.

FIG. 8 is a schematic structural diagram of a forward-backward boost-buck charging and discharging circuit according to an eighth embodiment of the present disclosure. As illustrated in FIG. 8, a forward-backward boost-buck charging and discharging circuit 81 according to the embodiment of the present disclosure includes a battery 811, a forward-backward boost-back charging and discharging unit 812 and a first control unit 813, and a second control unit 814 connected to the first control unit 813. The second control unit 814 is configured to trigger the first control unit 813 to control the forward-backward boost-buck charging and discharging unit 812 to boost or buck to supply power to a load, and to control the forward-backward boost-buck charging and discharging unit 812 to boost or buck an external input voltage to charge the battery 1.

For example, when detecting that a voltage required at the output end of the forward-backward boost-buck charging and discharging circuit is lower than a DC voltage of the battery 811, the second control unit 814 sends a first control signal to the first control unit 813; and after receiving the first control signal, the first control unit 813 controls the forward-backward boost-buck charging and discharging unit 812 to buck and output the voltage supplied by the battery 811 to the output end. When detecting that the voltage required at the output end of the forward-backward boost-buck charging and discharging circuit is higher than the DC voltage of the battery 811, the second control unit 814 sends a second control signal to the first control unit 813; and after receiving the second control signal, the first control unit 813 controls the forward-backward boost-buck charging and discharging unit 812 to buck and output the voltage supplied by the battery 811 to the output end. The second control unit 814 may adopt a control chip, and may be selected according to actual needs, which is not limited herein.

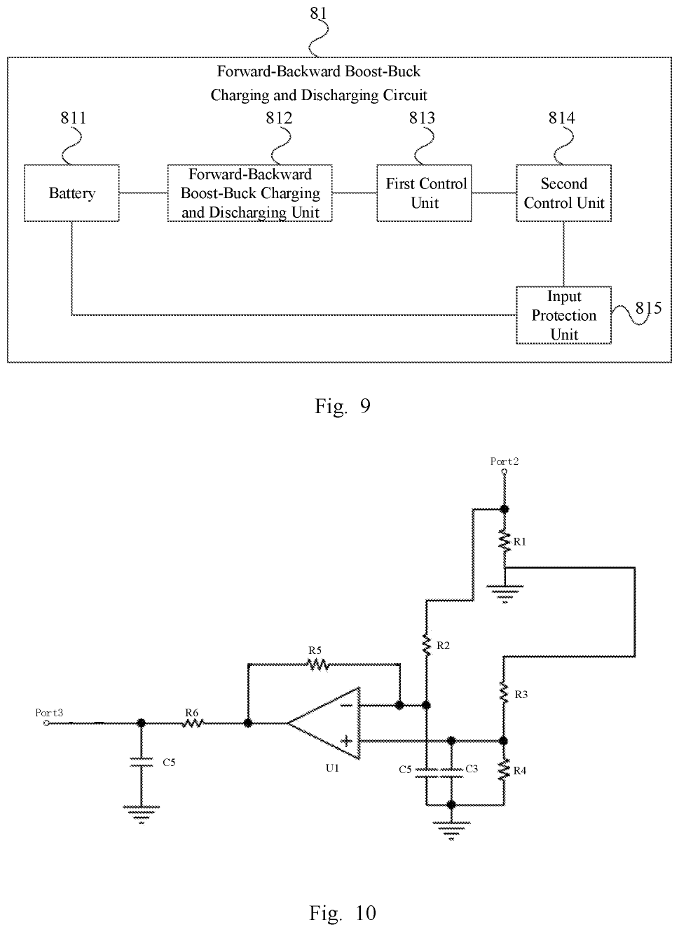

FIG. 9 is a schematic structural diagram of the forward-backward boost-buck charging and discharging circuit according to a ninth embodiment of the present disclosure. As illustrated in FIG. 9, on the basis of the aforementioned embodiments, the forward-backward boost-buck charging and discharging circuit according to the embodiment of the present disclosure further includes an input protection unit 815 connected to the second control unit 814 and configured to perform an overcurrent protection for the forward-backward boost-buck charging and discharging circuit 81.

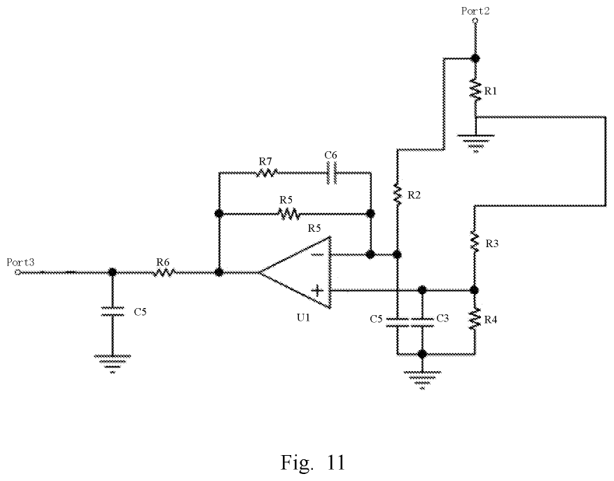

FIG. 10 is a schematic structural diagram of an input protection unit according to a tenth embodiment of the present disclosure. As illustrated in FIG. 10, on the basis of the aforementioned embodiments, the input protection unit 815 further includes a first resistor R1, a second resistor R2, a third resistor R3, a fourth resistor R4, a fifth resistor R5, a sixth resistor R6, a third capacitor C3, a fourth capacitor C4, a fifth capacitor C5 and a comparator U1, wherein;
a first end of the first resistor R1 is grounded, a second end of the first resistor R1 is connected to a first end of the second resistor R2, and the second end of the first resistor R1 is coupled to an cathode circuit of the battery 1; a first end of the third capacitor C3 is connected to a second end of the second resistor R2, and a second end of the third capacitor C3 is grounded; a first end of the third resistor R3 is grounded, a second end of the third resistor R3 is connected to a first end of the fourth resistor R4 and a first end of the fourth capacitor C4, respectively, and a second end of the fourth resistor R4 and a second end of the fourth capacitor C4 are grounded; a first input end of the comparator U1 is connected to the second end of the second resistor R2, a second input end of the comparator U1 is connected between the third resistor R3 and the fourth resistor R4, and an output end of the comparator U1 is connected to a first end of the sixth resistor R6; a first end of the fifth resistor R5 is connected to a second end of the sixth resistor R6, a second end of the fifth resistor R5 is connected to an output end of the comparator U1, the second end of the sixth resistor R6 is connected to a first end of the fifth capacitor C5, a second end of the fifth capacitor C5 is grounded, and the second end of the sixth resistor R6 is connected to the second control unit 814.

Specifically, the first end of the first resistor R1 is grounded, and the second end of the first resistor R1 is coupled to the cathode of the battery 1; an overcurrent detection signal of the first resistor R1 is acquired by the third resistor R3, amplified by the comparator U1, and then flows into a detection pin of the second control unit 814 through the sixth resistor R6. When the detection current obtained by the detection pin of the second control unit 814 exceeds an overcurrent threshold, the second control unit 814 sends a turn-off signal to the first control unit 813, so that the forward-backward boost-buck charging and discharging circuit 81 stops working, thereby improving the working safety of the circuit. In which, the third capacitor C3, the fourth capacitor C4 and the fifth capacitor C5 function for filtering to reduce interferences. The fifth resistor R5 provides an amplification stage of the comparator U1. The sixth resistor R6 functions for current limiting. In which, the first resistor R1 may be coupled to an cathode circuit of the battery 1 through a common mode choke. The overcurrent threshold is set according to actual needs, which is not limited herein. The second end of the first resistor is Port2, and the second end of the sixth resistor is Port3.

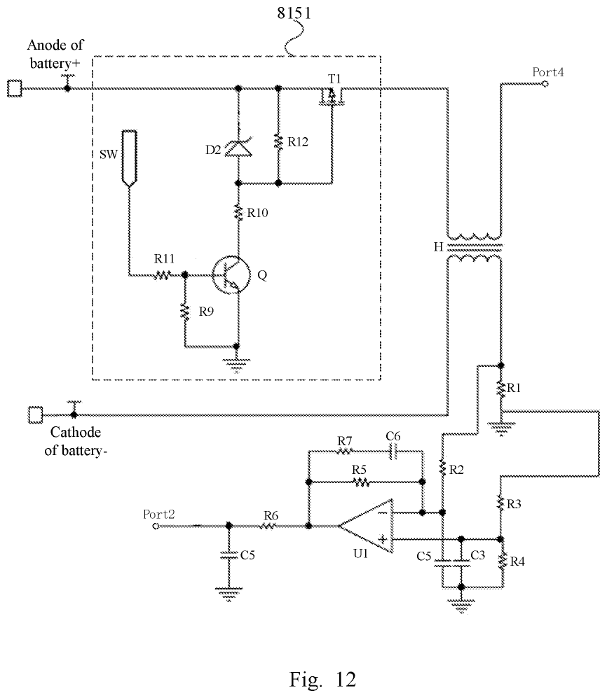

FIG. 11 is a schematic structural diagram of an input protection unit according to an eleventh embodiment of the present disclosure. As illustrated in FIG. 11, on the basis of the aforementioned embodiments, the input protection unit 815 further includes a seventh resistor R7 and a sixth capacitor C6, wherein:
a first end of the sixth capacitor C6 is connected to the first end of the fifth resistor R5, a second end of the sixth capacitor C6 is connected to a first end of the seventh resistor R7, and a second end of the seventh resistor R7 is connected to the second end of the fifth resistor R5. The sixth capacitor C6 and the fifth resistor R5 function to stabilize the comparator U1.

FIG. 12 is a schematic structural diagram of an input protection unit according to a twelfth embodiment of the present disclosure. As illustrated in FIG. 12, on the basis of the aforementioned embodiments, the input protection unit 815 further includes a switching unit 8151, which includes a ninth resistor R9, a tenth resistor R10, an eleventh resistor R11, a twelfth resistor R12, a triode Q, a voltage stabilizing diode D2, a field effect transistor T1 and a common mode choke H, wherein:
a first end of the eleventh resistor R11 is connected to the second control unit 814, a second end of the eleventh resistor R11 is connected to a base of the triode Q, an emitter of the triode Q is grounded, a first end of the ninth resistor R9 is connected to a second end of the eleventh resistor R11, a second end of the ninth resistor R9 is grounded, a first end of the tenth resistor R10 is connected to a collector of the triode Q, a second end of the tenth resistor R10 is connected to a first end of the voltage stabilizing diode D2, a first end of the twelfth resistor R12 and a source of the field effect transistor T1, respectively, a second end of the voltage stabilizing diode D2 and a second end of the twelfth resistor R12 are connected to a gate of the field effect transistor T1, respectively, a drain of the field effect transistor T1 is connected to the common mode choke H, the gate of the field effect transistor T1 is connected to a anode of the battery 811, and the common mode choke H is connected to an cathode of the battery 811.

As illustrated in FIG. 12, on the basis of the aforementioned embodiments, further, the first resistor R1 is coupled to the cathode circuit of the battery 811 through the common mode choke H, the first end of the third resistor R3 is grounded, the first end of the sixth resistor R6 is connected to the output end of the comparator U1, and the second end of the sixth resistor R6 is connected to the detection pin of the second control unit 814. The first end of the eleventh resistor R11 is connected to an overcurrent control pin SW of the second control unit 814, the second end of the eleventh resistor R11 is connected to the base of the triode Q, the emitter of the triode Q is grounded, the first end of the ninth resistor R9 is connected to the second end of the eleventh resistor R11, the second end of the ninth resistor R9 is grounded, the first end of the tenth resistor is connected to the collector of the triode Q, the second end of the tenth resistor is connected to the first end of the voltage stabilizing diode D2, the first end of the twelfth resistor R12 and the source of the field effect transistor T1, respectively, the second end of the voltage stabilizing diode D2 and the second end of the twelfth resistor R12 are connected to the gate of the field effect transistor T1, respectively, and the drain of the field effect transistor T1 is connected to the common mode choke H. Port4 may be connected to the forward-backward boost-buck charging and discharging unit 812.

When judging, through the input protection unit 815, that the cathode current of the detected battery 811 obtained by the detection pin exceeds the overcurrent threshold, the second control unit 814 outputs a control signal through the overcurrent control pin SW to turn off the triode Q, so as to control the field effect transistor T1 to be turned off, and then the common mode choke H is turned off, thereby disconnecting the power supply circuit of the forward-backward boost-back charging and discharging circuit.

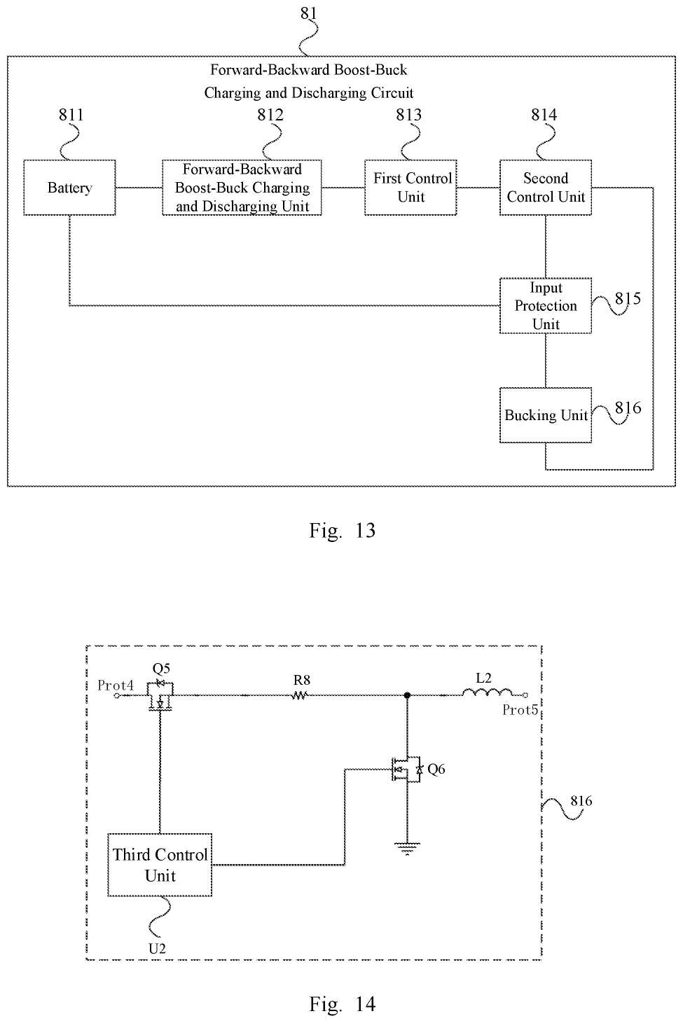

FIG. 13 is a schematic structural diagram of a forward-backward boost-buck charging and discharging circuit according to a thirteenth embodiment of the present disclosure. As illustrated in FIG. 13, on the basis of the aforementioned embodiments, the forward-backward boost-buck charging and discharging circuit further includes a bucking unit 816 and a second control unit. The bucking unit 816 is connected to the second control unit 814 and is configured to buck an output voltage of the switching unit 8151 to a preset voltage. In which, the preset voltage is set according to actual needs, which is not limited herein. An input end of the bucking unit 816 may be connected to the output end of the battery 811, and an output end of the bucking unit 816 may be connected to a load to supply power thereto.

FIG. 14 is a schematic structural diagram of a bucking unit according to a fourteenth embodiment of the present disclosure. As illustrated in FIG. 14, the bucking unit 816 includes a fifth switching tube Q5, a sixth switching tube Q6, an eighth resistor R8, a second inductor L2 and a third control unit U2, wherein a first end of the fifth switching tube Q5 is connected to the anode of the battery 811, a second end of the fifth switching tube Q5 is connected to a first end of the eighth resistor R8, a second end of the eighth resistor R8 is connected to a first end of the sixth switching tube Q6 and a first end of the second inductor L2, respectively, a second end of the sixth switching tube Q6 is grounded, a second end of the second inductor L2 is connected to a bucking output end, the fifth switching tube Q5 and the sixth switching tube Q6 are connected to the third control unit U2, respectively, and the third control unit U2 is connected to the second control unit 814.

Specifically, the fifth switching tube Q5 is an upper bridge arm of a bucking circuit, the sixth switching tube Q6 is a lower bridge arm of the bucking circuit, the third control unit U2 provides driving signals for the fifth switching tube Q5 and the sixth switching tube Q6, and the second inductor 12 is a freewheeling output inductor. The bucking unit 816 may buck and output the DC voltage supplied by the battery 1. The second control unit 814 sends a bucking output trigger signal to the third control unit U2, so that the third control unit U2 controls the fifth switching tube Q5 and the sixth switching tube Q6 to output a preset voltage. The third control unit U2 may adopt a control chip of model SC8002. Port4 is an input end of the bucking unit 816, and may be connected to the anode of the battery 811; and Port5 is an output end of the bucking unit 816, and may be externally connected to an input end of a load.

For example, the bucking unit 816 converts the input DC voltage of 16 to 22V supplied by the battery 811 into a vehicle-charging standard voltage of 12V/10 A and outputs it.

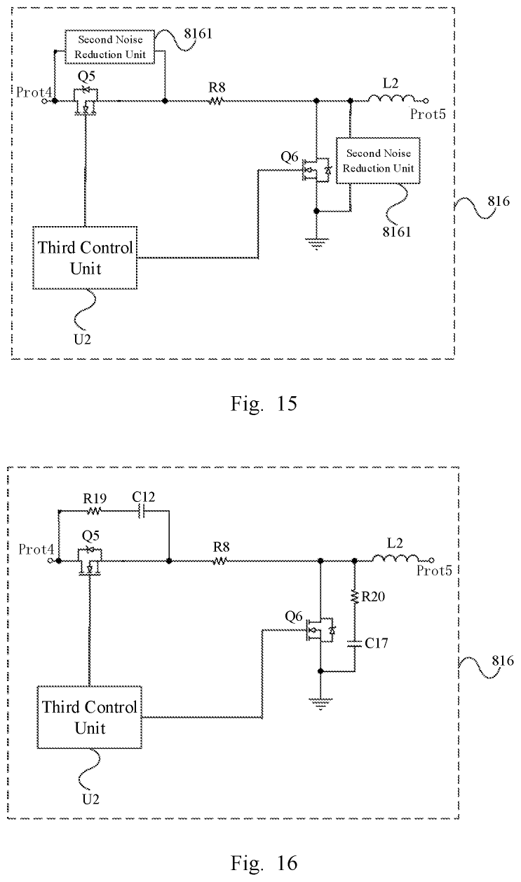

FIG. 15 is a schematic structural diagram of a bucking unit according to a fifteenth embodiment of the present disclosure. As illustrated in FIG. 15, on the basis of the aforementioned embodiments, the bucking unit 816 further includes at least one second noise reduction unit 8161, which is connected in parallel with the fifth switching tube Q5 or the sixth switching tube Q6, and is configured to reduce a noise signal of the switching tube.

Specifically, at least one second noise reduction unit 8161 may be connected in parallel with one or more of the fifth switching tube Q5 and the sixth switching tube Q6. The specific arrangement mode and the number of the second noise reduction units 8161 are set according to actual needs, which is not limited herein.

For example, FIG. 16 is a schematic structural diagram of a voltage reduction unit according to a sixteenth embodiment of the present application. As illustrated in FIG. 16, on the basis of the aforementioned embodiments, the second noise reduction unit 8161 further includes a fifth noise reduction unit and a sixth noise reduction unit, wherein:
the fifth noise reduction unit includes a nineteenth resistor R19 and a twelfth capacitor C12, wherein the nineteenth resistor R19 is connected in series with the twelfth capacitor C12 and then connected in parallel with the fifth switching tube Q5; the sixth noise reduction unit includes a twentieth resistor R20 and a thirteenth capacitor C17, wherein the twentieth resistor R20 is connected in series with the thirteenth capacitor C17 and then connected in parallel with the sixth switching tube Q6. The fifth noise reduction unit and the sixth noise reduction unit function to reduce a noise signal of the switching tube.

An embodiment of the present disclosure provides an electric tool, which includes the forward-backward boost-buck charging and discharging circuit according to any of the aforementioned embodiments. The electric tool includes but is not limited to a cigarette lighter.

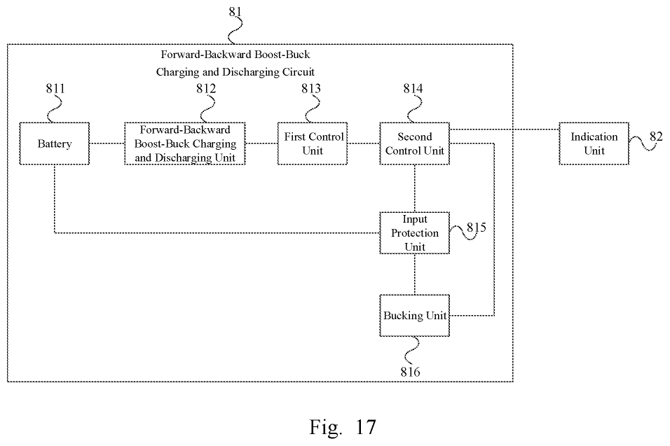

FIG. 17 is a schematic structural diagram of an electric tool according to a seventeenth embodiment of the present disclosure. As illustrated in FIG. 17, on the basis of the aforementioned 30 embodiments, the electric tool according to the embodiment of the present disclosure further includes a forward-backward boost-buck charging and discharging circuit 81, a second control unit 814, an input protection unit 815, a bucking unit 816 and an indication unit 82, wherein:
the forward-backward boost-buck charging and discharging circuit 81 includes a battery 811, a forward-backward boost-buck charging and discharging unit 812 and a first control unit 813. The second control unit 814 is connected to the first control unit 813, the input protection unit 815, the bucking unit 816 and the indication unit 82, respectively. The bucking unit 816 is connected to the battery 811 and is configured to buck and output the voltage of the battery 811. The input protection unit 815 is connected to the battery 811 and is configured to perform an overcurrent protection for the forward-backward boost-buck charging and discharging circuit 81, The indication unit 82 is configured to make an overcurrent prompt according to an instruction of the second control unit 814.

When detecting an overcurrent through the input protection unit 815, the second control unit 814 may send an overcurrent indication signal to the indication unit 82, which may make an overcurrent prompt according to the overcurrent indication signal. For example, the indication unit 82 includes an LED indicator, which lights up after the indication unit 82 receives the overcurrent indication signal.

The electric tool according to the present disclosure has the advantages of small volume, high power, light weight and the like, realizes the forward-backward boost-buck charging and discharging of the rechargeable battery, and supplies energy to the load through the battery; meanwhile, after the battery is used up, the battery may be fully recharged using a charging interface such as a USB-C port. The input protection unit is disposed to collect the current flowing into the cathode of the battery, and the second control unit turns off an enable pin signal of the first control unit after judging the overcurrent, so that the forward-backward boost-buck charging and discharging circuit stops working, and sends an overcurrent indication signal to the indication unit, so that the indication unit makes an overcurrent prompt, thereby improving the use safety of the electric tool. In addition, the power supply function similar to the vehicle charging output port can be realized by the bucking unit, thereby supplying power for a DC 12V appliance of 120 W full-power.

In the present disclosure, descriptions referring to the terms such as ‘an embodiment’, ‘a specific embodiment’, ‘some embodiments’, ‘for example’, ‘an example’, ‘a specific example’ or ‘some examples’ mean that the specific features, structures, materials or characteristics described in connection with the embodiment(s) or example(s) are included in at least one embodiment or example of the present disclosure. In the present disclosure, the schematic expressions of the above terms do not necessarily refer to a same embodiment or example. Further, the specific features, structures, materials or characteristics described may be combined in any one or more embodiments or examples in a suitable manner.

The above specific embodiments further explain the objectives, technical solutions and advantageous effects of the present disclosure in detail. It should be understood that those described above are only specific embodiments of the present disclosure, and are not intended to limit the protection scope of the present disclosure. Any modification, equivalent substitution, improvement, etc. made within the spirit and principle of the present disclosure should fall within the protection scope of the present disclosure.

1. A forward-backward boost-buck charging and discharging circuit, comprising a battery, a forward-backward boost-buck charging and discharging unit and a first control unit, wherein:
the battery is configured to store power and supply power to a load;
the forward-backward boost-buck charging and discharging unit is configured to charge and discharge the battery;
the first control unit is configured to control the forward-backward boost-buck charging and discharging unit to boost or buck to supply power to the load, and to control the forward-backward boost-buck charging and discharging unit to boost or buck an external input voltage to charge the battery;
the battery is connected to the forward-backward boost-buck charging and discharging unit, and the forward-backward boost-buck charging and discharging unit is connected to the first control unit.

2. The forward-backward boost-buck charging and discharging circuit according to claim 1, wherein the forward-backward boost-buck charging and discharging unit comprises a first switching tube, a second switching tube, a third switching tube, a fourth switching tube, a first inductor, a first capacitor and a second capacitor, wherein:
the first switching tube is connected in series with the second switching tube, the third switching tube is connected in series with the fourth switching tube, a anode of the battery is connected to a first end of the first switching tube, the first end of the first switching tube is connected to a first end of the first capacitor, a second end of the first capacitor is connected to a first end of the second capacitor, a second end of the second capacitor is connected to a first end of the third switching tube, the second end of the first capacitor and the first end of the second capacitor are grounded, a first end of the first inductor is connected between the first switching tube and the second switching tube, a second end of the first inductor is connected between the third switching tube and the fourth switching tube, a second end of the second switching tube and a second end of the fourth switching tube are connected to an cathode of the battery, respectively;
the first control unit is configured to drive the first switching tube, the second switching tube, the third switching tube and the fourth switching tube, so as to boost or buck the battery to supply power to the load, and to boost or buck the external input voltage to charge the battery.

3. The forward-backward boost-buck charging and discharging circuit according to claim 2, further comprising a current limiting unit configured to perform a current limiting protection for the forward-backward boost-buck charging and discharging circuit.

4. The forward-backward boost-buck charging and discharging circuit according to claim 2, further comprising at least one noise reduction unit, which is connected in parallel with the first switching tube, the second switching tube, the third switching tube or the fourth switching tube.

5. The forward-backward boost-buck charging and discharging circuit according to claim 1, further comprising at least one filter capacitor, each of which is connected in parallel with the battery.

6. The forward-backward boost-buck charging and discharging circuit according to claim 1, further comprising a second control unit, which is connected to the first control unit and is configured to trigger the first control unit to control the forward-backward boost-buck charging and discharging unit to boost or buck to supply power to the load, and to control the forward-backward boost-buck charging and discharging unit to boost or buck the external input voltage to charge the battery.

7. The forward-backward boost-buck charging and discharging circuit according to claim 6, further comprising an input protection unit, which is connected to the second control unit and is configured to perform an overcurrent protection for the forward-backward boost-buck charging and discharging circuit.

8. The forward-backward boost-buck charging and discharging circuit according to claim 7, wherein the input protection unit comprises a first resistor, a second resistor, a third resistor, a fourth resistor, a fifth resistor, a sixth resistor, a third capacitor, a fourth capacitor, a fifth capacitor and a comparator, wherein:
a first end of the first resistor is grounded, a second end of the first resistor is connected to a first end of the second resistor, and the second end of the first resistor is coupled to an cathode circuit of the battery; a first end of the third capacitor is connected to a second end of the second resistor, and a second end of the third capacitor is grounded; a first end of the third resistor is grounded, a second end of the third resistor is connected to a first end of the fourth resistor and a first end of the fourth capacitor, respectively, and a second end of the fourth resistor and a second end of the fourth capacitor are grounded; a first input end of the comparator is connected to the second end of the second resistor, a second input end of the comparator is connected between the third resistor and the fourth resistor, and an output end of the comparator is connected to a first end of the sixth resistor; a first end of the fifth resistor is connected to a second end of the sixth resistor, a second end of the fifth resistor is connected to an output end of the comparator, the second end of the sixth resistor is connected to a first end of the fifth capacitor, a second end of the fifth capacitor is grounded, and the second end of the sixth resistor is connected to the second control unit.

9. The forward-backward boost-buck charging and discharging circuit according to claim 8, wherein the input protection unit further comprises a seventh resistor and a sixth capacitor, wherein:
a first end of the sixth capacitor is connected to the first end of the fifth resistor, a second end of the sixth capacitor is connected to a first end of the seventh resistor, and a second end of the seventh resistor is connected to the second end of the fifth resistor.

10. The forward-backward boost-buck charging and discharging circuit according to claim 7, wherein the input protection unit comprises a switching unit, which comprises a ninth resistor, a tenth resistor, an eleventh resistor, a twelfth resistor, a triode, a voltage stabilizing diode, a field effect transistor and a common mode choke, wherein:
a first end of the eleventh resistor is connected to the second control unit, a second end of the eleventh resistor is connected to a base of the triode, an emitter of the triode is grounded, a first end of the ninth resistor is connected to a second end of the eleventh resistor, a second end of the ninth resistor is grounded, a first end of the tenth resistor is connected to a collector of the triode, a second end of the tenth resistor is connected to a first end of the voltage stabilizing diode, a first end of the twelfth resistor and a source of the field effect transistor, respectively, a second end of the voltage stabilizing diode and a second end of the twelfth resistor are connected to a gate of the field effect transistor, respectively, a drain of the field effect transistor is connected to the common mode choke, the gate of the field effect transistor is connected to a anode of the battery, and the common mode choke is connected to an cathode of the battery.

11. The forward-backward boost-buck charging and discharging circuit according to claim 10, further comprising a bucking unit, which is connected to the second control unit and is configured to buck an output voltage of the switching unit to a preset voltage.

12. The forward-backward boost-buck charging and discharging circuit according to claim 11, wherein the bucking unit comprises a fifth switching tube, a sixth switching tube, an eighth resistor, a second inductor and a third control unit, wherein:
a first end of the fifth switching tube is connected to the anode of the battery, a second end of the fifth switching tube is connected to a first end of the eighth resistor, a second end of the eighth resistor is connected to a first end of the sixth switching tube and a first end of the second inductor, respectively, a second end of the sixth switching tube is grounded, a second end of the second inductor is connected to a bucking output end, and the fifth switching tube and the sixth switching tube are connected to the third control unit, respectively.

13. The forward-backward boost-buck charging and discharging circuit according to claim 12, wherein the bucking unit further comprises at least one second noise reduction unit which is connected in parallel with the fifth switching tube or the sixth switching tube.

14. An electric tool, comprising a forward-backward boost-buck charging and discharging circuit, the forward-backward boost-buck charging and discharging circuit, comprising a battery, a forward-backward boost-buck charging and discharging unit and a first control unit, wherein:
the battery is configured to store power and supply power to a load;
the forward-backward boost-buck charging and discharging unit is configured to charge and discharge the battery;
the first control unit is configured to control the forward-backward boost-buck charging and discharging unit to boost or buck to supply power to the load, and to control the forward-backward boost-buck charging and discharging unit to boost or buck an external input voltage to charge the battery;
the battery is connected to the forward-backward boost-buck charging and discharging unit, and the forward-backward boost-buck charging and discharging unit is connected to the first control unit.

15. The forward-backward boost-buck charging and discharging circuit according to claim 14, wherein the forward-backward boost-buck charging and discharging unit comprises a first switching tube, a second switching tube, a third switching tube, a fourth switching tube, a first inductor, a first capacitor and a second capacitor, wherein:
the first switching tube is connected in series with the second switching tube, the third switching tube is connected in series with the fourth switching tube, a anode of the battery is connected to a first end of the first switching tube, the first end of the first switching tube is connected to a first end of the first capacitor, a second end of the first capacitor is connected to a first end of the second capacitor, a second end of the second capacitor is connected to a first end of the third switching tube, the second end of the first capacitor and the first end of the second capacitor are grounded, a first end of the first inductor is connected between the first switching tube and the second switching tube, a second end of the first inductor is connected between the third switching tube and the fourth switching tube, a second end of the second switching tube and a second end of the fourth switching tube are connected to an cathode of the battery, respectively;
the first control unit is configured to drive the first switching tube, the second switching tube, the third switching tube and the fourth switching tube, so as to boost or buck the battery to supply power to the load, and to boost or buck the external input voltage to charge the battery.

16. The forward-backward boost-buck charging and discharging circuit according to claim 15, further comprising a current limiting unit configured to perform a current limiting protection for the forward-backward boost-buck charging and discharging circuit.

17. The forward-backward boost-buck charging and discharging circuit according to claim 15, further comprising at least one noise reduction unit, which is connected in parallel with the first switching tube, the second switching tube, the third switching tube or the fourth switching tube.

18. The forward-backward boost-buck charging and discharging circuit according to claim 14, further comprising at least one filter capacitor, each of which is connected in parallel with the battery.

19. The forward-backward boost-buck charging and discharging circuit according to claim 14, further comprising a second control unit, which is connected to the first control unit and is configured to trigger the first control unit to control the forward-backward boost-buck charging and discharging unit to boost or buck to supply power to the load, and to control the forward-backward boost-buck charging and discharging unit to boost or buck the external input voltage to charge the battery.

20. The forward-backward boost-buck charging and discharging circuit according to claim 19, further comprising an input protection unit, which is connected to the second control unit and is configured to perform an overcurrent protection for the forward-backward boost-buck charging and discharging circuit.
